(19) United States
(12) Patent Application Publication
(10) Pub. No.: US 2018/0278902 A1
(43) Pub. Date: Sep. 27, 2018

(54) PROJECTION DEVICE, CONTENT DETERMINATION DEVICE AND PROJECTION METHOD

(71) Applicant: SHARP KABUSHIKI KAISHA, Sakai City, Osaka (JP)

(72) Inventors: TAKUTO ICHIKAWA, Sakai City (JP); KENICHI IWAUCHI, Sakai City (JP); MAKOTO OHTSU, Sakai City (JP); TAICHI MIYAKE, Sakai City (JP)

(21) Appl. No.: 15/764,328

(22) PCT Filed: Sep. 28, 2016
(86) PCT No.: PCT/JP2016/078565

§ 371 Date: Mar. 29, 2018

(30) Foreign Application Priority Data
Sep. 29, 2015 (JP) 2015-192080

(51) Int. Cl. H04N 9/31; G06T 7/55; H04N 13/128

(52) U.S. Cl. CPC H04N 9/3179; H04N 5/247; H04N 13/128; G06T 7/55

(57) ABSTRACT

Provided is a technique for projecting appropriate contents in accordance with different places of work. A projection device (101) is provided with a distance acquisition unit (201) configured to acquire the distance between an object and the projection device, a content acquisition unit (203) configured to acquire content information containing a video to be projected and the projection distance of the video, a projection video determination unit (205) configured to refer to the content information acquired by the content acquisition unit in accordance with the distance acquired by the distance acquisition unit and determine the video to be projected, and a projection processing unit (206) configured to project the video determined by the video determination unit on the object.

### TECHNICAL FIELD

An aspect of the present invention relates to a technique for superimposing and displaying contents on an object.

### BACKGROUND ART

Previously, there have been projection devices that project visual information such as a graphic, a character, a still image, and a video, or the like on an object. As a way for utilizing these projection devices, there is a projection type Augmented Reality (AR) technique in which a video generated or processed on a computer is projected from a projection device and the video is superimposed on an object in a real space. The AR technique may be applied, for example, to superimpose and display a working method on a working object at a worksite, or to superimpose and display a diagnostic image on a human body at a medical site. Thus, information may be shown intuitively.

As an implementation method of the AR technique, an optical see-through type in which a video is superimposed on a real space using a half mirror, or the like, and the superimposed video is directly projected on the retina; a video see-through type in which a real space is photographed with a camera, a video is superimposed on the photographed image, and the superimposed video is shown, or the like, is cited. The projection type AR technique has an advantage over these types in that multiple viewers may see the same AR information at the same time.

In recent years, a handheld projection type AR technique has been developed along with downsizing of the projection devices. NPL 1 discloses a method for photographing an object with a camera, detecting a projection position, and projecting a video in accordance with the projection position.

In addition, PTL 1 discloses a method for extracting a shape of an object and projecting a video in accordance with the extracted shape of the object as another method for projecting a video in accordance with a projection position.

Further, PTL 2 discloses a method for detecting a projection area and projecting a video in accordance with the detected projection area.

### CITATION LIST

### Patent Literature

PTL 1: JP 2013-218019 A (published on Oct. 24, 2013)
PTL 2: JP 2011-8019 A (published on Jan. 13, 2011)

### Non Patent Literature

NPL 1: “HideOut”, The Walt Disney Company, [online], [Searched on Aug. 25, 2015], Internet <http://www.disneyresearch.com/project/hideout/>

### SUMMARY OF INVENTION

### Technical Problem

However, in the method described in NPL 1, although the projection position is considered in the case of projecting the video, a projection distance is not considered. Further, in the method described in PTL 1, although the shape of the object is considered in the case of projecting the video, a projection distance is not considered. In addition, in the method described in PTL 2, although a projection distance is considered in the case of detecting the projection area, the projection distance is not considered for contents of the projected video.

In a case that contents are projected on a place of work at an actual site, the place of work on which the contents are to be projected varies moment by moment depending on working circumstances, thus a projection distance from a projection device whose position is fixed to the place of work varies. Accordingly, as in the above-described related art, a problem arises in which appropriate contents may not be projected in accordance with different places of work unless the projection distance is considered for the projected contents.

An aspect of the present invention is made in view of the above-described problems, and an object thereof is to provide a technique for projecting appropriate contents in accordance with different places of work.

### Solution to Problem

To solve the above-described problems, a projection device according to an aspect of the present invention is a projection device configured to project contents on a projected object, and includes a distance acquisition unit configured to acquire a distance between the projected object and the projection device, a content information acquisition unit configured to acquire content information containing contents projected from the projection device and a projection distance of the contents, a content determination unit configured to refer to the content information acquired by the content information acquisition unit in accordance with the distance acquired by the distance acquisition unit and determine contents to be projected, and a projection processing unit configured to project the contents determined by the content determination unit on the projected object.

A content determination device according to an aspect of the present invention is a content determination device configured to determine contents to be projected from a projection device on a projected object, and includes a storage unit configured to store content information containing contents projected and a projection distance of the contents, and a content determination unit configured to refer to the content information in accordance with a distance between the projected object and the projection device and determining contents to be projected.

A projection method according to an aspect of the present invention is a projection method with a projection device configured to project contents on a projection object. The projection method includes the steps of acquiring a distance between the projected object and the projection device, acquiring content information containing contents projected from the projection device and a projection distance of the contents, referring to the content information acquired in the content information acquisition unit in accordance with the distance acquired in the distance acquisition unit and determining contents to be projected, and projecting the contents determined in the determining the contents on the projected object.

### Advantageous Effects of Invention

According to an aspect of the present invention, appropriate contents may be projected in accordance with different places of work.

### BRIEF DESCRIPTION OF DRAWINGS

FIG. 1 is a schematic diagram of a usage scene of a projection device according to a first embodiment.

FIG. 2 is a diagram illustrating an example of a functional block configuration of the projection device according to the first embodiment.

FIG. 3 is a diagram illustrating a block configuration of a distance acquisition unit according to the first embodiment.

FIGS. 4A and 4B are diagrams illustrating acquisition of a projection distance according to the first embodiment.

FIG. 5 is a diagram illustrating acquisition of a projection distance by a photographing unit.

FIG. 6 is a diagram illustrating a configuration of content information according to the first embodiment.

FIG. 7 is a flowchart according to the first embodiment.

FIG. 8 is a diagram illustrating acquisition of a projection distance according to a second embodiment.

FIG. 9 is a diagram illustrating a configuration of content information according to a third embodiment.

FIG. 10 is a diagram illustrating a functional block configuration of a projection device according to a fourth embodiment.

FIG. 11 is a diagram illustrating acquisition of a projection distance and a projection angle according to the fourth embodiment.

### DESCRIPTION OF EMBODIMENTS

Hereinafter, embodiments of the present invention are described in detail with reference to the drawings. In the drawings, portions having the same function will be given the same reference signs and repeated description thereof will be omitted.

### First Embodiment

In the present embodiment, a basic configuration according to an aspect of the present invention is described.

### How to Use Device

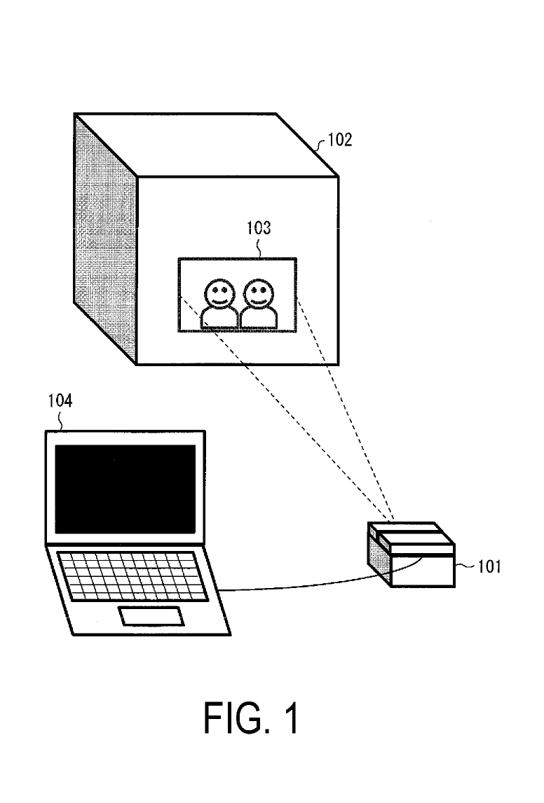

FIG. 1 is a diagram schematically illustrating a state in which display on an object is performed, using a projection device in the first embodiment of the present invention capable of superimposing and displaying a video on an object.

An external input device 104 according to the present embodiment outputs information containing a projection video (hereinafter, referred to as content information) to a projection device 101. The projection device 101 acquires a distance between the projection device 101 and a projected object 102 (hereinafter, referred to as a projection distance), refers to the content information acquired from the external input device 104 in accordance with the projection distance, determines a video 103, and projects the video 103 on the projected object 102. The projected object 102 corresponds to a screen on which the video 103 is projected. The video 103 is projected on the projected object 102 by the projection device 101.

Note that, in the embodiment of the present invention, although projecting the video on the projected object is described, what is projected is not limited to the video, and may be other contents (for example, a graphic, a character, a still image, or the like).

### Functional Block Configuration

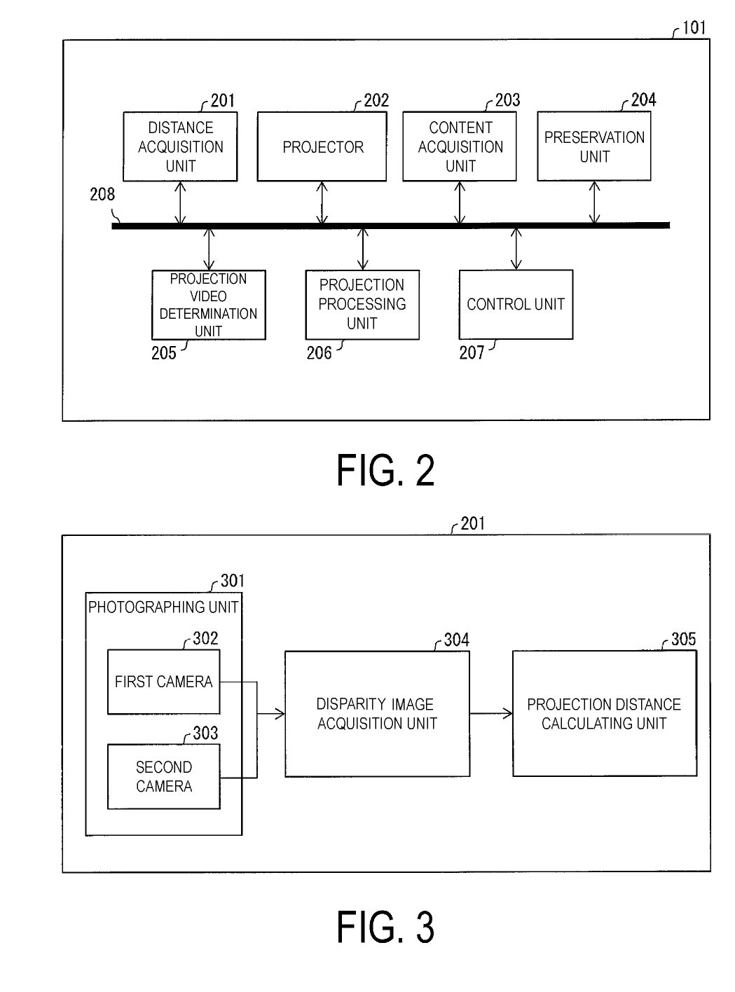

FIG. 2 is a diagram illustrating an example of a functional block configuration of the projection device 101 according to the present embodiment. The projection device 101 includes a distance acquisition unit 201 for acquiring a projection distance; a projector 202 for projecting a video on a projected object; a content acquisition unit (content information acquisition unit) 203 for acquiring content information from the external input device 104; a preservation unit (storage unit) 204 for storing the acquired content information, a result of video processing, and various data used for the video processing; a projection video determination unit (content determination unit) 205 for determining a video projected on the projected object from the acquired content information in accordance with the acquired projection distance; a projection processing unit 206 for generating drawing data from the projection video determined in the projection video determination unit 205, and outputting the drawing data to the projector; a control unit 207 for performing overall control; and a data bus 208 for exchanging data among individual blocks. Note that, in FIG. 1, although the projection device 101 has a configuration in which the above-described functions are included in a housing, the projection device 101 is not limited to the configuration, and may have a configuration in which the above functions are independent of each other; a configuration in which the content acquisition unit 203, the preservation unit 204, the projection video determination unit 205, the projection processing unit 206, the control unit 207, and the data bus 208 are configured with, for example, a commercially available personal computer (PC); or the like.

The distance acquisition unit 201 is configured with a device capable of directly or indirectly acquiring a distance between the projection device 101 and the projected object 102. A device capable of directly acquiring the above-described distance refers to a device capable of directly measuring an actual distance, such as a laser distance meter. A device capable of indirectly acquiring the above-described distance refers to a device capable of calculating a distance using an indirect value, such as a triangulation meter. Details of a configuration of the distance acquisition unit 201 are described later.

The projector 202 is configured with a Digital Light Processing (DLP) projector, a liquid crystal projector, or the like, and displays the video outputted from the projection processing unit 206.

The content acquisition unit 203 is configured with a Field Programmable Gate Array (FPGA), an Application Specific Integrated Circuit (ASIC), or the like. Further, the content acquisition unit 203 includes an input/output port such as a Universal Serial Bus (USB), and operates as an interface with the external input device 104.

The content acquisition unit 203 acquires content information that is information for a video projected from the external input device 104 via the input/output port, and stores the content information in the preservation unit 204. Here, the external input device 104 is configured with a device into which content information may be inputted directly using a keyboard or a mouse, for example, an external storage device capable of retaining previously generated content information, or the like. Details of the content information are described later.

The preservation unit 204 is configured with a storage device such as a Random Access Memory (RAM) and a hard disk, for example, and in which content information, a video processing result, or the like is stored.

The projection video determination unit 205 is configured with FPGA, ASIC, or the like, refers to the projection distance acquired in the distance acquisition unit 201 and the content information acquired in the content acquisition unit 203 and stored in the preservation unit 204, and determines a video to be projected. A method for determining the video to be projected is described later.

The projection processing unit 206 is configured with FPGA, ASIC, or a Graphics Processing Unit (GPU), generates the drawing data from the video determined in the projection video determination unit 205, and outputs the drawing data to the projector 202.

The control unit 207 is configured with a Central Processing Unit (CPU) or the like, and controls processing instructions, control, input/output of data, or the like in each of functional blocks.

The data bus 208 is a bus for exchanging data among respective units.

Note that, a device including the preservation unit 204 and the projection video determination unit 205 as a content determination device for determining contents (e.g., a video) projected from the projection device 101 on the projected object 102 may be configured using a PC, or the like, for example.

### Configuration of Distance Acquisition Unit

Next, a configuration of the distance acquisition unit 201 according to the present embodiment is described using FIG. 3.

As illustrated in FIG. 3, the distance acquisition unit 201 includes a photographing unit 301 for acquiring a video of a photographing range containing the projected object 102 illustrated in FIG. 1; a disparity image acquisition unit 304 that is inputted the image acquired in the photographing unit 301 and computes a disparity image; a projection distance calculating unit 305 for referring to the disparity image acquired in the disparity image acquisition unit 304 and an installation condition of the photographing unit 301 and calculating a projection distance. In addition, the photographing unit 301 includes a first camera 302 and a second camera 303. It is sufficient that the distance acquisition unit 201 is a device capable of directly or indirectly acquiring a distance between a projection device and a projected object, and, for example, a commercially available distance measuring device such as a laser distance meter may be used. Note that, the examples of the devices capable of directly or indirectly acquiring the distance are as described above.

The first camera 302 and the second camera 303 are configured to include an image pickup device such as an optical component, a Complementary Metal Oxide Semiconductor (CMOS), and a Charge Coupled Device (CCD) for capturing a photographing space as an image, and output image data generated based on an electrical signal obtained by photoelectric conversion. The first camera 302 and the second camera 303 may output photographed information, as original data, or as video data that are image-processed (brightness imaging, noise removal, etc.) in advance so as to facilitate processing in a video processing unit (not illustrated), or may have a configuration to output both the data. In addition, the first camera 302 and the second camera 303 may be configured to send a camera parameter, such as an aperture value and a focal distance at a time of photographing, to the preservation unit 204.

The disparity image acquisition unit 304 is configured with FPGA, ASIC, or the like, is inputted images acquired in each of the first camera 302 and the second camera 303 of the photographing unit 301, computes a disparity image between these images, and outputs the disparity image to the projection distance calculating unit 305. A method for computing the disparity image is described later.

The projection distance calculating unit 305 is configured with FPGA, ASIC, or the like, refers to the disparity image acquired in the disparity image acquisition unit 304 and a positional relation between the first camera 302 and the second camera 303, and calculates a projection distance. A method for calculating the projection distance is described later.

### Acquisition Method of Disparity Image and Projection Distance

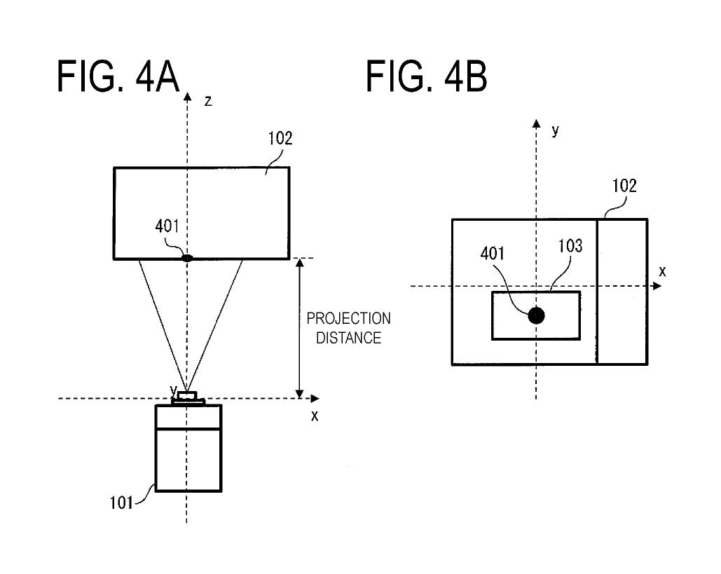

Next, an acquisition method of a disparity image and a projection distance in the distance acquisition unit 201 according to the present embodiment is described using FIGS. 4A and 4B. FIG. 4A is a bird's-eye view of a state in which the disparity image and the projection distance are acquired. FIG. 4B is a plan view of the state in which the disparity image and the projection distance are acquired. In FIGS. 4A and 4B, a distance detection point 401 indicates a position at which the projection distance is acquired by the distance acquisition unit 201. For example, in FIG. 4B, a center of the video 103 is the distance detection point 401. In the above-described case as the example that the laser distance meter is used as the distance acquisition unit 201, the distance detection point 401 is an irradiation position of the laser distance meter.

Further, in the following description, a coordinate system in which a position of the distance acquisition unit 201 of the projection device 101 is an origin, a lateral direction of the plan view (FIG. 4B) is an x coordinate (a right direction is a positive direction), a longitudinal direction of the plan view is a y coordinate (an upper direction is a positive direction), and a longitudinal direction of the bird's-eye view (FIG. 4A) is a z coordinate (an upper direction is a positive direction) is used as various coordinate systems.

Next, the acquisition method of the disparity image in the distance acquisition unit 201 according to the present embodiment is described.

A disparity refers to a difference between positions at which an object is shown on two images photographed at different positions. A disparity image represents the disparity as an image.

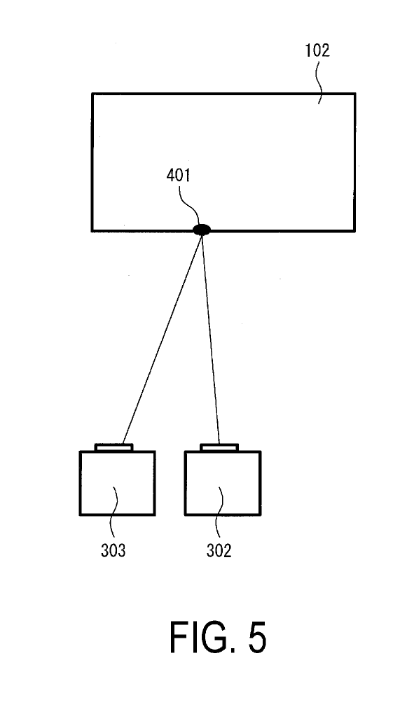

Toward the projected object 102, the first camera 302 is on a right side and the second camera 303 is on a left side. FIG. 5 is a diagram capturing the state from directly above. In FIG. 5, the distance detection point 401 denotes a point at which the projected object 102 is positioned, and the first camera 302 and the second camera 303 are further illustrated. Here, of the two cameras, the second camera 303 on the left side is a reference (reference camera) and a coordinate system of this camera is used as a reference coordinate system (hereinafter, referred to as a “reference coordinate system”). Meanwhile, the two cameras have the same performance, and are perfectly horizontally installed. Note that, in a case that the two cameras have different performances or in a case that the two cameras are installed not horizontally, correction is possible using camera geometry, but detailed description thereof is omitted. Further, there is no problem in particular, even in a case that right/left positional relation of the first camera 302 and the second camera 303 is reversed.

It is possible to obtain the disparity by selecting a local block of a predetermined size from images photographed using the reference camera, extracting a local block corresponding to the selected local block from images of the other camera using block matching, and calculating a deviation amount between the local blocks.

Here, a brightness value on a pixel (u,v) of the image photographed by the first camera 302 is IR (u,v), and a brightness value on a pixel (u,v) of the image photographed by the second camera 303 is IL (u,v). In a case that a search range of the local blocks in the block matching is P, and a size of the local block is 15*15, an equation for calculating a disparity M(u,v) is as follows.

$$[ Equation 1 ]$$

$$M ( u , v ) = {arg min}_{dx ∈ P} ( {\sum }_{s = - 7}^{7} {\sum }_{t = - 7}^{7} ( \vert {I}_{L} ( u + s , v + t ) - {I}_{R} ( u + s - dx , v + t ) \vert ) ) \qquad ( Equation 1 )$$

Here, argmin(·) is a parameter that minimizes the argument enclosed by the parenthesis, and is a function that calculates a parameter under argmin.

Since the first camera 302 and the second camera 303 are installed horizontally, it is sufficient that a search direction in the block matching is a horizontal direction only. Further, since a camera that is a search target is installed on the right side with respect to the reference camera, it is sufficient that the search direction is only to the left side (negative direction) with respect to a corresponding pixel position.

The disparity image may be computed with the above-described method. Note that, the computation method of the disparity image is not limited to the above-described method, and any method may be used as long as the method is capable of computing a disparity image of cameras installed at different positions.

Next, the acquisition method of the projection distance according to the present embodiment is described.

Camera parameters that indicate performance of cameras used for photographing are required to calculate a distance value from a disparity image. The camera parameters include internal parameters and external parameters. The internal parameters include focal distances and principal points of both the cameras. The external parameters include a rotation matrix and a translation vector between both the cameras.

The distance value may be calculated as follows, using a focal distance f (unit: m) and a distance between cameras b (unit: m), among the calculated camera parameters.

In a case that a pixel of the distance detection point 401 is a pixel (uc,vc) on a photographed face of the reference camera, a projection distance d may be obtained in accordance with a principle of triangulation, using the focal distance f, the distance between the cameras b, and a disparity M(uc,vc), with Equation 2.

$$[ Equation 2 ]$$

$$d = \frac{f \times b}{M ( {u}_{c} , {v}_{c} ) \times q} \qquad ( Equation 2 )$$

Here, q is a length per one pixel of an image (unit: m), and is a value determined depending on an image pickup device adopted for the camera. A deviation amount of pixels may be converted to a disparity of real distances using a product of M(xc,yc) and q.

Although the projection distance may be calculated using the above-described method, an arbitrary method may be used as a selection method of the point at which the projection distance is acquired, and, for example, a method in which a user selects the distance detection point 401 may be used.

Meanwhile, the number of the cameras in the photographing unit 301 is not limited to two, a photographing device capable of directly calculating the disparity or the distance may be used, and, for example, a photographing device of Time Of Flight (TOF) type measuring a distance based on a reflection time of infrared light to an object, or the like, may be applied.

### Content Information

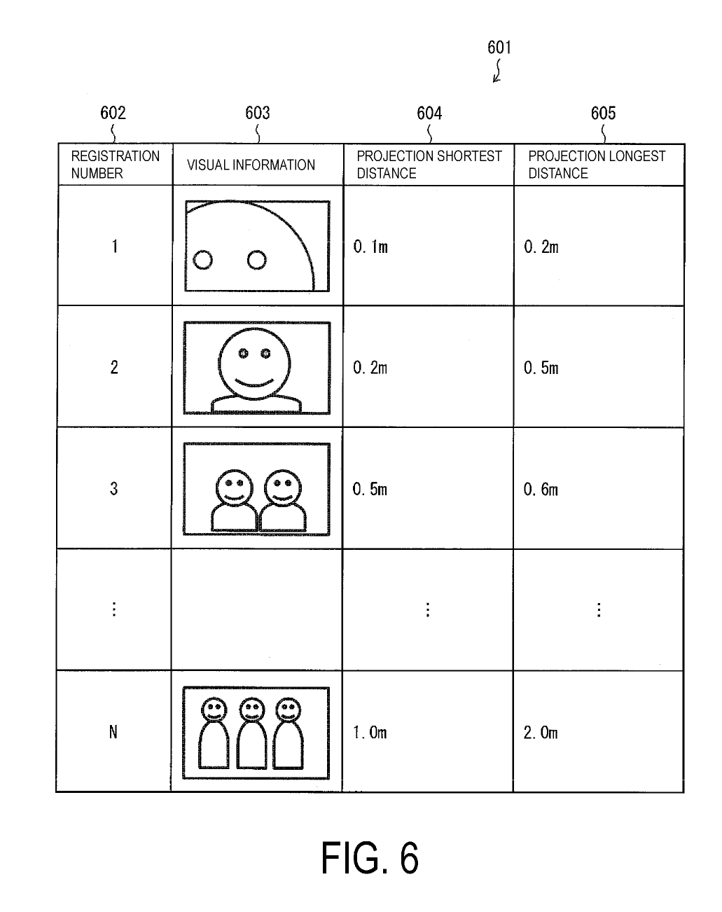

Next, content information acquired by the content acquisition unit 203 is described using FIG. 6. Inputted content information 601 contains, a registration number 602, visual information 603, a projection shortest distance 604, and a projection longest distance 605.

The registration number 602 is a unique number of the content information 601 to be registered.

The visual information 603 contains contents such as a character, a symbol, an image, and a motion picture. Here, as for the image, a generic format, for example, Bitmap, Joint Photographic Experts Group (JPEG), or the like, may be used. Further, as for the motion picture, a generic format, for example, Audio Video Interleave (AVI), Flash Video (FLV), or the like, may be used.

The projection shortest distance 604 is an item indicating a minimum value among distances for which the visual information 603 having the same registration number 602 may be projected. The projection longest distance 605 is an item indicating a maximum value among the distances for which the visual information 603 having the same registration number 602 may be projected. In other words, in a case that a projection distance falls within a range from the projection shortest distance 604 to the projection longest distance 605, the visual information 603 having the same registration number 602 may be projected clearly.

Note that, the visual information 603 is changed depending on a range of projection distances, as illustrated in FIG. 6. As the projection distance becomes shorter, more zoomed-in contents may be set on the visual information 603, for example. Further, contents that see through inside, may be set on the visual information 603, for example. As a specific example of this visual information 603, in a case that a video is projected on a cabinet, a white video (a video taken while illuminating with a flashlight) is projected in a case of projecting from a position farther than a predetermined distance, and, on the other hand, a video of inside the cabinet is projected in a case of projecting from a position closer than the predetermined distance may be cited.

### Determination Method of Projection Video

Next, a determination method of a projection video in the projection video determination unit 205 is described.

A projection distance acquired by the distance acquisition unit 201 is d, and the video 103 projected on the projected object 102 is V. The registration number 602 of the content information 601 is i, the visual information 603 having the registration number i is V(i), the projection shortest distance 604 having the registration number i is ds(i), and the projection longest distance 605 having the registration number i is dl(i). At this time, the video V projected on the projected object 102 is determined according to Equation 3.

[Equation 3]

V=V(i)(where, dₛ(i)≤d<dₗ(i)) (Equation 3)

### Flowchart

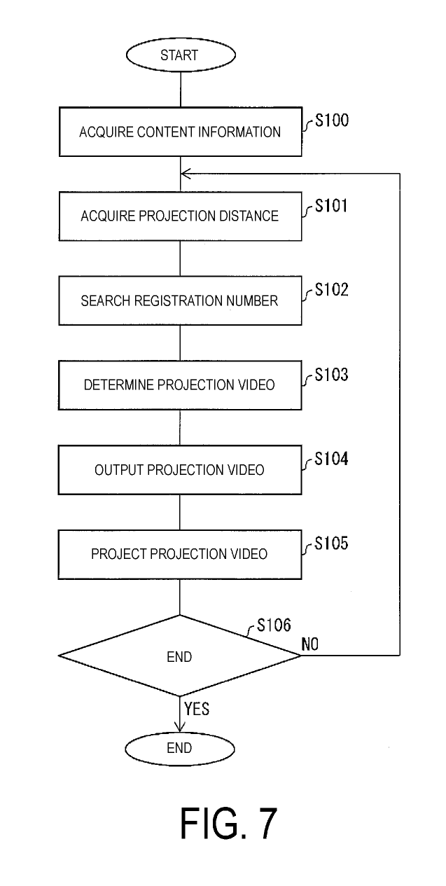

Next, a processing procedure in the present embodiment is described using FIG. 7.

FIG. 7 is a flowchart illustrating processing in which the projection device 101 acquires a projection distance, refers to the projection distance, and determines the video 103 to be projected on the projected object 102, and the video 103 is projected from the projection device 101 on the projected object 102.

In the projection device 101, the content acquisition unit 203 acquires content information from the external input device 104, and stores the content information in the preservation unit 204 (step S100). After the content information is acquired, the distance acquisition unit 201 acquires a projection distance (step S101). After the projection distance is acquired, the projection video determination unit 205 compares the acquired projection distance with the projection shortest distance 604 and the projection longest distance 605 of the content information 601 stored in the preservation unit 204, and searches a registration number 602 corresponding to a projection distance that is between the projection shortest distance 604 and the projection longest distance 605 (step S102).

The projection video determination unit 205 determines the visual information 603 having the registration number 602 found in step S102 as a projection video (step S103). The projection processing unit 206 reads the determined projection video from the preservation unit 204, generates drawing data, and outputs the drawing data to the projector 202 (step S104). The projector 202 projects the received drawing data on the projected object 102 (step S105). The control unit 207 determines whether to end the processing (step S106). In a case that the processing does not end and continues (step S106: NO), the processing returns to step S101, and repeats the above-described processing. In a case that the processing ends (step S106: YES), the whole processing ends.

With the above-described configuration, in the projection device 101 projecting a video on the projected object 102, a method for projecting contents in accordance with a distance between the projected object 102 and the projection device 101 may be provided.

### Second Embodiment

In the present embodiment, a method for acquiring projection distances at multiple positions of a projected object using the above-described disparity image, and projecting contents in accordance with the projection distance, on each of the positions of the projected object at which the projection distance is acquired is described.

Hereinafter, the method for projecting contents in accordance with the projection distance is described, while pointing out differences from the above-described method.

In the method described in the first embodiment, in the case that the projection distance is calculated, the projection distance is calculated for a specific point on the projected object. However, in a case that there are uneven portions on the projected object, the projection distance of the specific point may be significantly different from projection distances of the other points. Although a method in which projection distances are calculated for all pixels is capable of addressing this issue, there arises another issue that an amount of calculation increases. Thus, in the present embodiment, a method for acquiring projection distances at multiple positions on a projected object, and projecting contents in accordance with the projection distance, on each of the positions of the projected object at which the projection distance is acquired is used.

### Method for Calculating Projection Distance

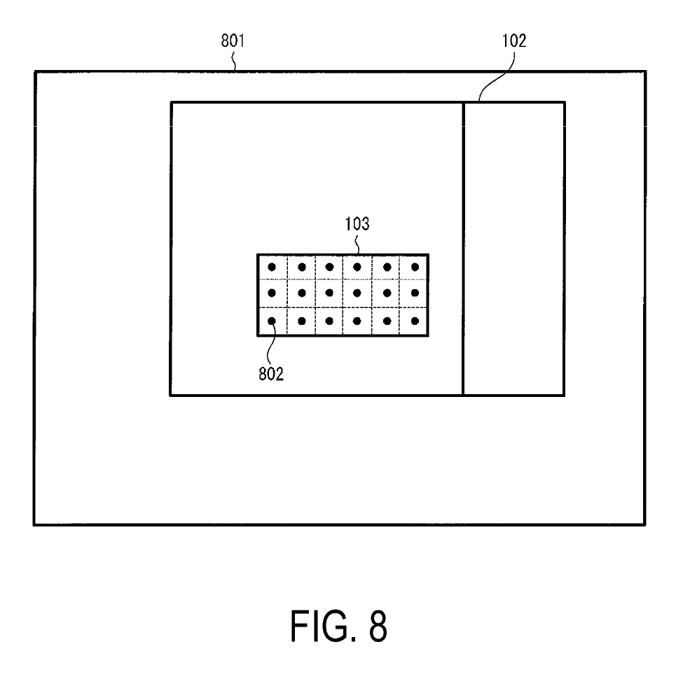

A calculation method of a projection distance in the present embodiment is described using FIG. 8.

FIG. 8 is a video photographed by a reference camera. In FIG. 8, in a video 801 photographed by the reference camera, an image including the video 103 on the projected object 102 being photographed is divided into 18 areas.

The distance acquisition unit 201 acquires a projection distance for a distance detection point 802 at each of the areas. Specifically, the distance acquisition unit 201 calculates a disparity for each of distance detection points (u1, v1) through (u18, v18) using Equation 4 and calculates a projection distance from the disparity using Equation 5.

$$[ Equation 4 ]$$

$$\begin{matrix}M ( {u}_{n} , {v}_{n} ) = {arg min}_{dx ∈ P} ( {\sum }_{s = - 7}^{7} {\sum }_{t = - 7}^{7} ( \vert {I}_{L} ( {u}_{n} + s , {v}_{n} + t ) - {I}_{R} ( {u}_{n} + s - dx , {v}_{n} + t ) \vert ) ) ( n = 1 , 2 , … , 18 ) \\ [ Equation 5 ] & ( Equation 4 ) \\ {d}_{n} = \frac{f \times b}{M ( {u}_{n} , {v}_{n} ) \times q} ( n = 1 , 2 , … , 18 ) & ( Equation 5 )\end{matrix}$$

### Determination Method of Projection Video

Next, a determination method of a projection video in the projection video determination unit 205 is described.

In the method described in the first embodiment, the projection distance is uniquely determined, thus the projection video determined from the content information is also uniquely determined. In the present embodiment, as a projection distance varies depending on each of areas, a method for determining a projection video for each of the areas is used.

First, the projection video determination unit 205 associates the distance detection point 802 with a pixel of a video projected from the projector 202. 3D coordinates of a distance detection point (un,vn) in a reference coordinate system are denoted as (Xn,Yn,Zn). At this time, the 3D coordinates of the distance detection point 802 and the pixel (u′n,v′n) of the video projected from the projector 202 have a relation in Equation 6.

$$[ Equation 6 ]$$

$$s ( \begin{matrix}{u}_{n}^{′} \\ {v}_{n}^{′} \\ 1\end{matrix} ) = A ( R ( \begin{matrix}{X}_{n} \\ {Y}_{n} \\ {Z}_{n}\end{matrix} ) + T ) ( n = 1 , 2 , … , 17 ) \qquad ( Equation 6 )$$

In Equation 6, s is a parameter dependent on the projection distance. A is a 3*3 matrix meaning an internal parameter of the projector. R is a 3*3 matrix meaning rotation of coordinates. T is a vector meaning translation of coordinates. It is possible that A, R and T are predetermined using a generic image processing method, for example, Zhang's method, or the like.

A projection distance of a pixel of a projection video corresponding to a distance detection point may be acquired using the conversion in Equation 6.

Note that, a pixel for which it is not possible to acquire a projection distance with the conversion in Equation 6 may be interpolated using detection points in the vicinity of the pixel. Although an arbitrary method may be used as a method for the interpolation, the pixel between the detection points is interpolated using, for example, a nearest neighbor method.

A projection distance at a point (u′,v′) on the video 103 projected from the projector 202 is d(u′,v′), and the video 103 projected on the projected object 102 is V. A registration number of the content information 601 is i, the visual information 603 having the registration number i is V(i), a projection shortest distance having the registration number i is ds(i), and a projection longest distance having the registration number i is dl(i). At this time, the projection video determination unit 205 determines a video V(u′,v′) to be projected on the projected object in accordance with Equation 7.

[Equation 7]

V(u′,v′)=V(i)(where, dₛ(i)<d(u′,v′)<dₗ(i)) (Equation 7)

The projection processing unit 206 synthesizes the visual information V(u′,v′), and the projector 202 outputs the visual information V(u′,v′).

With the above-described method, it is possible to project contents in accordance with the projection distance on each of the positions of the projected object at which the projection distance is acquired. Note that, the number of the divided areas of the video 103 is not limited to 18, and other numbers may be used.

With the above-described method, a method for acquiring projection distances for multiple positions of a projected object using a disparity image, and projecting contents in accordance with the projection distance, on each of the positions of the projected object at which the projection distance is acquired while suppressing an amount of calculation may be provided.

### Third Embodiment

In the present embodiment, content information contains 3D model data, and a method for determining a projection video from the 3D model data in accordance with a projection distance is described.

### Functional Block Configuration

A functional block configuration of a projection device according to the present embodiment is the same as those of the first embodiment and the second embodiment (see FIG. 2). The present embodiment differs from the first embodiment and the second embodiment in that content information acquired by the content acquisition unit 203 contains 3D model data, and in that the projection video determination unit 205 determines a projection video from a projection distance and model information of the 3D model data.

With the above-described method, in a case that a projection video is projected in accordance with subtle variation in a projection distance, it is necessary to acquire a large amount of visual information of content information, thus there is an issue that an amount of content information increases significantly, and it is difficult to generate the content information. In comparison with this, it is possible to suppress the increase in the amount of content information in the present embodiment by including the 3D model data in the content information. Further, the content information is easily generated.

### Content Information

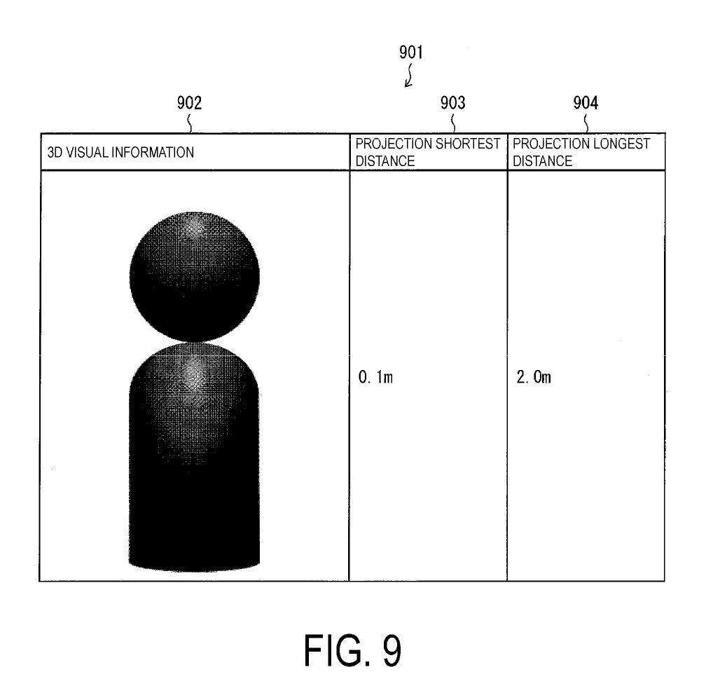

The content information used in the present embodiment is described using FIG. 9. FIG. 9 is a diagram schematically illustrating a configuration of content information 901.

As illustrated in FIG. 9, the content information 901 contains 3D visual information 902, a projection shortest distance 903, and a projection longest distance 904.

The 3D visual information 902 is stereoscopic information containing size information in a width direction, a height direction, and a depth direction.

Here, a format of the stereoscopic information may be a generic format, for example, Wavefront Object (Wavefront OBJ), FilmBox (FBX), or the like.

The projection shortest distance 903 is an item indicating a shortest distance among projection distances for which the 3D visual information 902 is projected. The projection longest distance 904 is an item indicating a longest distance among the projection distances for which the 3D visual information 902 is projected. In other words, in a case that a projection distance falls within a range from the projection shortest distance 903 to the projection longest distance 904, the 3D visual information 902 may be projected clearly.

### Determination Method of Projection Video

Next, a determination method of a projection video in the projection video determination unit 205 is described.

A projection distance acquired by the distance acquisition unit 201 is d, and the video 103 projected on the projected object 102 is V. A depth of the 3D visual information 902 is D, a coordinate in the depth direction with a center of the 3D visual information 902 being an origin is z, a cross-sectional video at the coordinate z of the 3D visual information 902 is I(z), a projection shortest distance is ds, and a projection longest distance is dl. At this time, the projection video determination unit 205 determines the video V to be projected on the projected object in accordance with Equation 8.

$$[ Equation 8 ]$$

$$V = I ( \frac{D}{{d}_{l} - {d}_{s}} ( 2 d - {d}_{l} - {d}_{s} ) ) ( where , {d}_{s} \leq d < {d}_{l} ) \qquad ( Equation 8 )$$

With the above-described method, by including 3D model data in content information, it is possible to provide a method for extracting a projection video in accordance with a projection distance from the 3D model data, and projecting the projection video on an object.

### Fourth Embodiment

In the present embodiment, a method for extracting a projection video in accordance with a projection distance and a projection angle, and projecting the projection video on an object is described. This method is capable of improving expressive power because projection contents vary depending on the projection angle even in a case that a projection video is projected at the same position of a projected object with the same projection distance.

### Functional Block Configuration

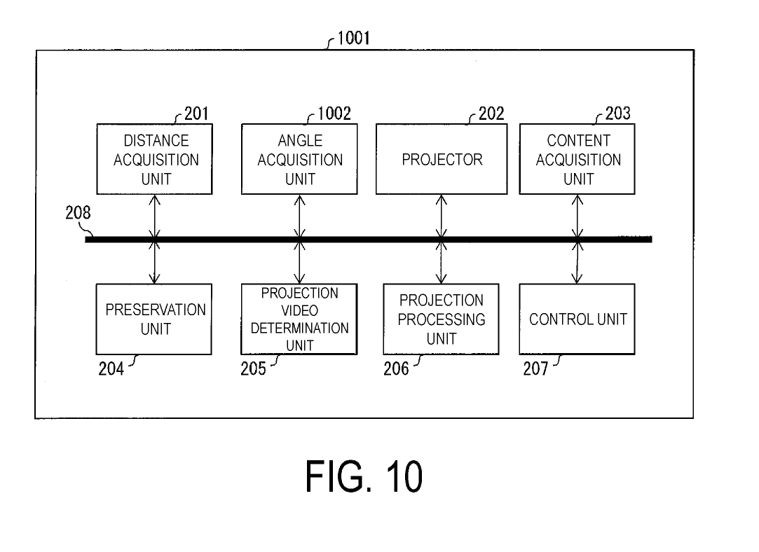

FIG. 10 is a diagram illustrating an example of a functional block configuration of a projection device 1001 according to the present embodiment. A difference from the first embodiment is that the projection device 1001 includes an angle acquisition unit 1002 for acquiring an angle that is defined by the projection devices 1001 and the projected object 102.

It is sufficient that the angle acquisition unit 1002 is a device capable of directly or indirectly calculating an angle that is defined by the projection device 1001 and the projected object 102, and, for example, a commercially available device such as an acceleration sensor and an angular velocity sensor may be used. Further, the angle acquisition unit 1002 may detect the above-described angle using images photographed by the distance acquisition unit 201. A device capable of directly calculating the above-described angle refers to a device capable of directly measuring an actual angle, such as a protractor. A device capable of indirectly acquiring the above-described angle refers to a device capable of calculating an angle using an indirect value, such as a triangulation meter.

### Method for Acquiring Projection Angle

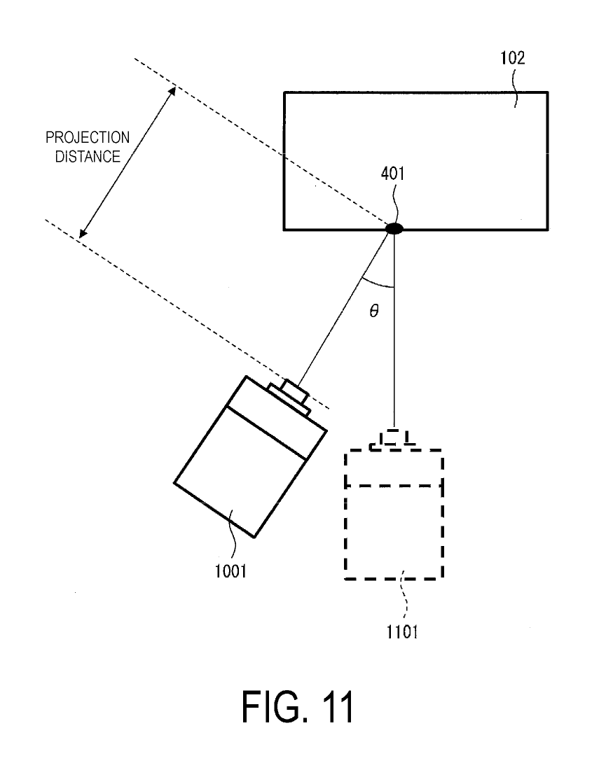

Next, a method for acquiring a projection angle is described using FIG. 11.

FIG. 11 is a bird's-eye view of a state in which a projection distance is acquired. The projection device 1001 is in a state of being rotated clockwise by an angle θ with an axis parallel to a y axis and passing through the distance detection point 401 being a center, from a front position facing a projection surface of the projected object 102. The angle θ is the projection angle. Here, as a specific method for acquiring the projection angle θ, there are following methods.

A first method is a method in which, a video photographed by the photographing unit 301 is referred, projection distances for four or more distance detection points 401 are acquired, and a projection surface is computed, in order to acquire the projection angle θ. In this case, it is possible to determine a precise projection angle because a projection angle defined by a projection device and a projected object is calculated one by one.

A second method is a method in which, an angle defined by the projection device 1101 at an initial position (front position of the projected object 102) and the projected object 102 is 90°, and a rotation angle of the projection device is detected using a device such as the acceleration sensor and the angular velocity sensor. In this case, it is not necessary to acquire a projection distance in a case that there are uneven portions on the projected object 102, thus a precise projection angle may be determined.

Any method other than the above-described methods may be used as long as the angle defined by the projection device and the projected object may be acquired precisely.

### Determination Method of Projection Video

A projection distance acquired by the distance acquisition unit 201 is d, and the video 103 projected on the projected object 102 is V. A depth of the 3D visual information 902 of the content information 901 is D, a coordinate in the depth direction with a center of the 3D visual information 902 being an origin is z, a cross-sectional video of a face rotated clockwise by θ around the y axis with the center of the 3D visual information 902 being the origin at the coordinate z of the 3D visual information 902 is I(z,θ), and the projection shortest distance 903 and the projection longest distance 904 of the content information 901 are ds and dl, respectively. At this time, the projection video determination unit 205 determines the video V to be projected on the projected object 102 in accordance with Equation 9.

$$[ Equation 9 ]$$

$$V = I ( \frac{D}{{d}_{l} - {d}_{s}} ( 2 d - {d}_{l} - {d}_{s} ) , θ ) ( where , {d}_{s} \leq d < {d}_{l} ) \qquad ( Equation 9 )$$

With the above-described method, it is possible to project contents in accordance with a projection distance and a projection angle. Note that, the projection angle is not limited to a rotation angle around one axis, and rotation angles around two or more axes may be used.

As described above, it is possible to provide a method for extracting and projecting a projection video in accordance with a projection distance and a projection angle.

### About First to Fourth Embodiments

In each of the above-described embodiments, the configurations illustrated in the attached drawings, or the like, are merely examples, and the present invention is not limited thereto, and modifications may appropriately be implemented within a range that exerts the effects of each of the aspects of the present invention. In addition, modifications may be implemented within a range not departing from the scope of the objectives of each of the aspects of the present invention.

In each of the above-described embodiments, although projecting a video on an object is described, what is projected is not limited to the video, and may be other contents (for example, a graphic, a character, a still image, or the like).

In the description of each of the embodiments, it is assumed that respective constituent elements for enabling functions are different units, however, it is not required that units capable of being clearly and separately recognized are actually included in this way. In a device for supporting remote operation that enables the functions of each of the above-described embodiments, respective constituent elements for enabling the functions may be configured using actually different units, for example, or all the constituent elements may be implemented in an LSI chip. In other words, whatever the implementations are, it is sufficient that each of the constituent elements is included as the function. Meanwhile, each of the constituent elements of the present invention may be arbitrarily sorted out, and an invention including the sorted and selected constitutions is also included in each of the aspects of the present invention.

Further, a program for enabling functions described above in each of the embodiments may be recorded on a computer-readable recording medium to cause a computer system to read the program recorded on the recording medium for performing the processing of each of the units. The “computer system” here includes an OS and hardware components such as a peripheral device.

Further, the “computer system” includes environment for supplying a home page (or environment for display) in a case of utilizing a WWW system.

Furthermore, the “computer-readable recording medium” refers to a portable medium such as a flexible disk, a magneto-optical disk, a ROM, and a CD-ROM, and a storage device such as a hard disk built into the computer system. Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client. Furthermore, the above-described program may be configured to enable some of the functions described above, and additionally may be configured to enable the functions described above, in combination with a program already recorded in the computer system.

### Supplement

A projection device (101) according to a first aspect of the present invention is a projection device configured to project contents on a projected object, and includes a distance acquisition unit (201) configured to acquire a distance between the projected object and the projection device, a content information acquisition unit (content acquisition unit 203) configured to acquire content information containing contents projected from the projection device and a projection distance of the contents, a content determination unit (projection video determination unit 205) configured to refer to the content information acquired by the content information acquisition unit in accordance with the distance acquired by the distance acquisition unit and determine contents to be projected, and a projection processing unit (206) configured to project the contents determined by the content determination unit on the projected object.

With the above-described configuration, the distance between the projected object and the projection device (projection distance) is acquired, and the video is projected in accordance with the acquired distance. Accordingly, appropriate contents may be projected in accordance with different places of work.

In a projection device according to a second aspect of the present invention, in the above-described first aspect, the distance acquisition unit includes a photographing unit (301) configured to photograph an object containing the projected object, and may be configured to refer to an image of the object photographed by the photographing unit, and specify the distance.

With the above-described configuration, it is possible to specify a projection distance by referring to an image of a photographed object, and to project contents in accordance with the specified projection distance.

In a projection device according to a third aspect of the present invention, in the above-described first and the second aspects, the distance acquisition unit may be configured to acquire distances at multiple positions between the projected object and the projection device, and the content determination unit may be configured to refer to the content information acquired by the content information acquisition unit in accordance with the distance for each position of the projected object, and determine contents to be projected.

With the above-described configuration, by acquiring projection distances at multiple positions of a projected object, it is possible to project contents in accordance with the projection distance for each of the positions at which the projection distance is acquired.

In a projection device according to a fourth aspect of the present invention, in the above-described first to the third aspects, the content information acquisition unit may be configured to acquire 3D model data as contents of the content information, and the content determination unit may be configured to extract contents to be projected from the 3D model data in accordance with the distance.

With the above-described configuration, 3D model data may be acquired as content information, and contents extracted from the 3D model data may be projected in accordance with a projection distance.

In a projection device according to a fifth aspect of the present invention, in the above-described first to the fourth aspects, the angle acquisition unit (1002) configured to acquire an angle defined by the projection device and the projected object is further included, and the content determination unit may be configured to refer to the content information acquired by the content information acquisition unit in accordance with the distance acquired by the distance acquisition unit and the angle acquired by the angle acquisition unit, and determine contents.

With the above-described configuration, it is possible to acquire a projection distance and a projection angle, and to project contents in accordance with the acquired projection distance and the projection angle.

A content determination device according to a sixth aspect of the present invention is a content determination device configured to determine contents to be projected from a projection device on a projected object, and includes a storage unit (preservation unit 204) configured to store content information containing contents projected and a projection distance of the contents, and a content determination unit (projection video determination unit 205) configured to refer to the content information in accordance with a distance between the projected object and the projection device and determine contents to be projected.

A projection method according to a seventh aspect of the present invention is a projection method with a projection device configured to project contents on a projected object. The projection method includes the steps of acquiring a distance between the projected object and the projection device, acquiring content information containing contents projected from the projection device and a projection distance of the contents, referring to the content information acquired in the acquiring the content information in accordance with the distance acquired in the acquiring the distance and determining contents to be projected, and projecting the contents determined in the determining the contents on the projected object.

A projection device according to each of the aspects of the present invention may be enabled with a computer, in this case, a program of the projection device for enabling the above-described projection device with the computer by causing the computer to operate as each of the units included in the above-described projection device, also falls within a range of an aspect of the present invention.

The present invention is not limited to each of the above-described embodiments, various modifications are possible within the scope of the present invention defined by aspects, and embodiments that are made by suitably combining technical means disclosed according to the different embodiments are also included in the technical scope of an aspect of the present invention. Further, when technical elements disclosed in the respective embodiments are combined, it is possible to form a new technical feature.

### CROSS-REFERENCE OF RELATED APPLICATION

This application claims the benefit of priority to JP 2015-192080 filed on Sep. 29, 2015, which is incorporated herein by reference in its entirety.

### REFERENCE SIGNS LIST

101 Projection device
201 Distance acquisition unit
203 Content acquisition unit (content information acquisition unit)
204 Preservation unit (storage unit)
205 Projection video determination unit (content determination unit)
206 Projection processing unit
1002 Angle acquisition unit

1-8. (canceled)

9. A projection device configured to project contents on a first object as a projected object, the projection device comprising:
a projection processing circuitry configured to, in accordance with a distance between the first object and the projection device, project, on the first object, contents indicative of an inside of a second object.

10. The projection device according to claim 9,
wherein the second object is the first object, and
the projection processing circuitry is configured to project, on the first object, the contents indicative of the inside of the first object in a case where the distance is shorter than a predetermined distance.

11. The projection device according to claim 9,
wherein the second object is a 3D model, and
the projection processing circuitry is configured to project, on the first object, a cross section of the 3D model which cross section is taken at a position corresponding to the distance.

12. The projection device according to claim 11, further comprising:
an angle acquisition circuitry configured to acquire an angle defined by the projection device and the first object,
wherein the projection processing circuitry is configured to project, on the first object, a cross section of the 3D model which cross section is taken at a position corresponding to the distance and which cross section corresponds to the angle.

13. The projection device according to claim 9, further comprising:
a photographing circuitry configured to photograph a third object including the first object,
wherein the projection device is configured to refer to an image of the third object photographed by the photographing circuitry and specify the distance.

14. The projection device according to claim 9,
wherein the projection processing circuitry is configured to project the contents on the first object in accordance with a distance between each of a plurality of positions on the first object and the projection device.

15. A projection method with a projection device configured to project contents on a first object as a projected object, the method comprising the step of:
in accordance with a distance between the first object and the projection device, projecting, on the first object, contents indicative of an inside of a second object.

16. A non-transitory computer-readable recording medium in which a program causing a computer to function as the projection device according to claim 9 is recorded.
